(19) United States
(12) Patent Application Publication
(10) Pub. No.: US 2016/0362622 A1
(43) Pub. Date: Dec. 15, 2016

(54) SEAL POT DESIGN

(71) Applicant: RES USA, LLC, WESTMINSTER, CO (US)

(72) Inventors: WEIBIN JIANG, ENGLEWOOD, CO (US); BRUCE E. MCCOMISH, MITCHELL, SD (US); BRYAN C. BORUM, COMMERCE CITY, CO (US); BENJAMIN H. CARRYER, DUBUQUE, IA (US); MARK D. IBSEN, HIGHLANDS RANCH, CO (US); MARK K. ROBERTSON, DENVER, CO (US); ERIC R. ELROD, ARVADA, CO (US); SIM WEEKS, DULUTH, GA (US); HAROLD A. WRIGHT, LONGMONT, CO (US)

(73) Assignee: RES USA, LLC

(21) Appl. No.: 15/248,930

(22) Filed: Aug. 26, 2016

Related U.S. Application Data
(63) Continuation of application No. 13/652,001, filed on Oct. 15, 2012.
(60) Provisional application No. 61/551,580, filed on Oct. 26, 2011.

(51) Int. Cl. C10J 3/48; C01B 3/02; C10J 3/72

(52) U.S. Cl. CPC C10J 3/48; C10J 3/721; C01B 3/02; C10J 2200/09

(57) ABSTRACT

An apparatus including at least one seal pot having at least one penetration through a surface other than the top of the seal pot, each of the at least one penetrations being configured for introduction, into the at least one seal pot, of solids from a separator upstream of the at least one seal pot; a substantially non-circular cross section; or both at least one penetration through a surface other than the top of the seal pot and a substantially non-circular cross section.

### CROSS-REFERENCE TO RELATED APPLICATIONS

This application is a continuation application of U.S. patent application Ser. No. 13/652,001 filed Oct. 15, 2012, which claims the benefit under 35 U.S.C. §119(e) of U.S. Provisional Pat. App. No. 61/551,580, filed Oct. 26, 2011. The disclosures of said applications are hereby incorporated herein by reference in their entirety.

### STATEMENT REGARDING FEDERALLY SPONSORED RESEARCH OR DEVELOPMENT

Not applicable.

### BACKGROUND

Field of the Invention

This disclosure relates generally to the field of synthesis gas production. More specifically, the disclosure relates to production of synthesis gas via dual fluidized bed gasification. Still more specifically, the disclosure relates to the design of seal pots utilized to maintain a pressure differential between a pyrolyzer and combustor of a dual fluidized bed gasifier.

Background of Invention

Gasification is utilized to produce process gas suitable for the production of various chemicals, for the production of Fischer-Tropsch liquid hydrocarbons, and for the production of power. Many feed materials may serve as carbonaceous sources for gasification, including, for example, shredded bark, wood chips, sawdust, sludges (e.g., sewage sludge), municipal solid waste (MSW), Refuse Derived Fuel (RDF), and a variety of other carbonaceous materials.

Dual fluidized bed (‘DFB’) indirect gasification utilizes a fluidized bed pyrolyzer (or ‘gasifier’) fluidly connected with a fluidized bed combustor, whereby heat for endothermic pyrolysis in the gasifier is provided by combustion of fuel in the combustor and transfer of combustion heat from the combustor to the pyrolyzer via circulation of a heat transfer medium (‘HTM’). Operation of a dual fluidized bed gasifier requires substantially continuous recycle of the heat transfer medium from the pyrolyzer, in which the temperature of the heat transfer material is reduced, to the combustor, in which the temperature of the heat transfer material is increased, and back. When the pyrolyzer and the combustor of a dual fluidized bed gasifier are operated at different pressures, the transfer lines, by which the pyrolyzer and the combustor are fluidly connected for transfer of heat transfer material, must be sealed in order to maintain a desired pressure differential between the pyrolyzer and the combustor. Generally, seal pots and/or valves (e.g., L valves or J-valves) are utilized to maintain the pressure differential and thus ensure that the product gas produced in the pyrolyzer (also referred to herein as syngas′, ‘synthesis gas,’ and ‘gasification product gas’) never comes into contact with the combustor flue gas, comprising air, emanating from the combustor.

There is a need in the art for improved devices for sealing transfer lines configured for transfer of reduced temperature heat transfer material from a pyrolyzer of a dual fluidized bed gasifier to a combustor thereof and for sealing transfer lines configured for transfer of increased temperature heat transfer material from a combustor of a DFB indirect gasifier to a pyrolyzer thereof, whereby a desired pressure differential may be maintained between the pyrolyzer and the combustor.

### SUMMARY

Herein disclosed is an apparatus comprising: at least one seal pot comprising: (a) at least one penetration through a surface other than the top of the seal pot, wherein each of the at least one penetrations is configured for introduction, into the at least one seal pot, of solids from a separator upstream of the at least one seal pot; (b) a substantially non-circular cross section; or both (a) and (b). In embodiments, the at least one seal pot comprises at least two penetrations through a surface other than the top of the seal pot, and each of the at least two penetrations is configured for introduction of solids from a separator upstream of the at least one seal pot. In embodiments, the at least one seal pot comprises at least one penetration through a surface other than the top of the seal pot, and further comprises at least one penetration through the top of the seal pot.

In embodiments, the apparatus further comprises at least one separator upstream of the at least one seal pot, and the at least one upstream separator is selected from the group consisting of gas/solid separators configured to separate solids from a gas in which solids are entrained. In embodiments, the at least one upstream separator is a cyclone separator. In embodiments, the at least one seal pot comprises at least one penetration through a surface other than the top of the seal pot, the cyclone comprises a dipleg, and the dipleg extends through the at least one penetration through a surface other than the top of the seal pot.

In embodiments, the at least one seal pot comprises at least one penetration through a surface other than the top of the seal pot, and further comprises at least one other penetration through a surface of the seal pot, the apparatus further comprises at least two separators upstream of the at least one seal pot, each of the at least two upstream separators comprises a dipleg, and at least one of the at least two diplegs extends through the at least one penetration through a surface other than the top of the seal pot, and another of the at least two diplegs extends through the at least one other penetration. The at least one other penetration may penetrate through a surface other than the top of the seal pot. The at least one seal pot can have a diameter of less than about 1 m or less than about 3 m. In embodiments, at least one other penetration passes through the top of the seal pot. In embodiments, the shape of at least one penetration through a surface other than the top of the seal pot is substantially elliptical.

In embodiments, at least one angle selected from the group consisting of an angle between the at least one dipleg passing through the at least one penetration through a surface other than the top of the seal pot and the surface other than the top of the seal pot; and an angle between the another of the at least two diplegs passing through the at least one other penetration and the surface penetrated by the at least one other penetration, is less than about 45°. In embodiments, the at least one angle is less than about 30°.

In embodiments, the apparatus comprises two separators upstream of the at least one seal pot, and one other penetration through the surface of the seal pot, for a total of two penetrations through surfaces of the seal pot, and each penetration is configured for introduction of solids from at least one of the two upstream separators via a dipleg thereof.

In embodiments, the apparatus comprises three upstream separators, each upstream separator comprising a dipleg; and two other penetrations through the seal pot, for a total of three penetrations through the seal pot configured for introduction of solids from at least one of the upstream separators via a dipleg thereof.

In embodiments, the minimum distance between any two of at least two diplegs extending into the seal pot is 10, 11, or 12 inches. In embodiments, the at least one seal pot further comprises a distributor configured for distributing a fluidization gas, and the minimum distance between the distributor and each of at least two diplegs extending into the at least one seal pot is 15, 16, 17 or 18 inches.

In embodiments, the at least one seal pot comprises a substantially non-circular cross section. In embodiments, the seal pot comprises a substantially rectangular cross section. In embodiments, such an at least one seal pot comprises at least two penetrations, each of the at least two penetrations configured for introduction of solids from an upstream separator, the apparatus further comprises at least two separators upstream of the at least one seal pot, each of the at least two upstream separators comprising a dipleg, and each of the at least two diplegs extends through one of the at least two penetrations of the seal pot. The minimum distance between any two of the at least two diplegs within the seal pot may be at least 10, 11, or 12 inches. The at least two penetrations may pass through the top of the at least one seal pot.

In embodiments, the apparatus further comprises a dual fluidized bed gasifier comprising a pyrolyzer and a combustor fluidly connected via a first transfer line configured for transfer of heat transfer material from the pyrolyzer to the combustor and a second transfer line configured for transfer of heat transfer material from the combustor back to the pyrolyzer. In such embodiments, the at least one seal pot may be a combustor seal pot positioned on the first transfer line and configured to prevent backflow of materials from the combustor to at least one gas/solid separator upstream of the combustor seal pot and downstream of the pyrolyzer. Such an apparatus may further comprise a valve selected from the group consisting of J valves and L valves, with the valve positioned on the second transfer line and configured to prevent backflow of materials from the pyrolyzer to at least one gas/solid separator upstream of the valve and downstream of the combustor.

In embodiments, the apparatus further comprises a dual fluidized bed gasifier comprising a pyrolyzer and a combustor fluidly connected via a first transfer line configured for transfer of heat transfer material from the pyrolyzer to the combustor and a second transfer line configured for transfer of heat transfer material from the combustor back to the pyrolyzer, and the at least one seal pot is a gasifier seal pot positioned on the second transfer line and configured to prevent backflow of materials from the pyrolyzer to at least one gas/solid separator upstream of the gasifier seal pot and downstream of the combustor.

In embodiments, the apparatus further comprises a dual fluidized bed gasifier comprising a pyrolyzer and a combustor fluidly connected via a first transfer line configured for transfer of heat transfer material from the pyrolyzer to the combustor and a second transfer line configured for transfer of heat transfer material from the combustor back to the pyrolyzer, and the apparatus comprises at least one combustor seal pot positioned on the first transfer line and configured to prevent backflow of materials from the combustor to at least one gas/solid separator upstream of the combustor seal pot and downstream of the pyrolyzer; and at least one gasifier seal pot positioned on the second transfer line and configured to prevent backflow of materials from the pyrolyzer to at least one gas/solid separator upstream of the gasifier seal pot and downstream of the combustor.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is schematic of a dual fluidized bed gasifier according to an embodiment of this disclosure;

FIG. 2A is a schematic of a prior art seal pot;

FIG. 2B is a schematic of a seal pot according to this disclosure; and

FIG. 3 depicts a cross-section of a seal pot according to this disclosure.

### NOTATION AND NOMENCLATURE

Certain terms are used throughout the following description and claims to refer to particular system components. This document does not intend to distinguish between components that differ in name but not function.

The terms ‘pyrolyzer’ and ‘gasifier’ are used interchangeably herein to refer to a reactor configured for endothermal pyrolysis. The term ‘gasifier’ may also be used herein to refer to a dual fluidized bed gasifier comprising a fluidized bed pyrolyzer fluidly connected with a fluidized bed combustor.

The terms ‘gasification product gas’, ‘syngas’, and ‘synthesis gas’ are used interchangeably herein unless otherwise indicated. That is, the ‘gasification product gas’ comprises hydrogen and carbon monoxide, and is thus also sometimes referred to herein as ‘synthesis gas’ or syngas′.

The terms ‘dipleg’ and ‘dip tube’ are utilized herein to refer to a solids return conduit fluidly connecting a gas/solid separator with a sealing device, e.g., a seal pot.

The term ‘carbonaceous feedstock’ is used herein to refer to any carbon-containing material that can be gasified to produce a product gas comprising hydrogen and carbon monoxide.

### DETAILED DESCRIPTION

Overview.

Herein disclosed are seal pots suitable for use in dual fluidized bed (also referred to herein as ‘DFB’) gasification, and methods of utilizing same. Also disclosed are a system and a method for the production of synthesis gas via dual fluidized bed gasification of a carbonaceous feedstock, the system and method employing at least one seal pot according to this disclosure. The disclosed seal pot is configured to balance the pressure between vessels operated at a pressure differential. In embodiments, the disclosed seal pot is incorporated into a dual fluidized bed gasification system comprising a pyrolyzer or ‘gasifier’ fluidly connected with a combustor. The pyrolyzer and combustor can operate at a pressure differential, with at least one seal pot according to this disclosure being utilized to balance the pressure therebetween, and provide a seal between one vessel and one or more separator(s) (e.g., one or more cyclone(s)) associated with the other vessel. For example, a seal pot according to this disclosure can be utilized to provide the seal between a pyrolyzer and one or more combustor cyclones, in which case the seal pot will be referred to herein as a ‘gasifier seal pot’; a seal pot according to this disclosure can be utilized to provide the seal between a combustor and gasifier cyclones, in which case the seal pot will be referred to herein as a ‘combustor seal pot’. In embodiments, a DFB indirect gasifier of this disclosure comprises at least one seal pot, as disclosed herein, which serves to balance the pressure differential between the two vessels (i.e. between the pyrolyzer or ‘gasifier’ and the combustor) and prevent gasification product gas (or ‘synthesis gas’) produced in the pyrolyzer from comingling with flue gas (typically containing excess process air) emanating from the combustor. The seal pots may thus also serve to reduce the risk of fire and/or explosive conditions in certain applications.

According to an embodiment of this disclosure, a seal pot is designed with non-top entry of one or more diplegs or dip tubes from one or more upstream separators (e.g., cyclone separator(s)). As mentioned hereinabove, the terms ‘dipleg’ and ‘dip tube’ are utilized herein to refer to a solids return conduit fluidly connecting a separator with a seal pot. In embodiments, the dipleg from at least one upstream separator enters the seal pot via a side thereof. Such a design may enable a reduction in the diameter of the seal pot relative to conventional designs incorporating solely top entrance(s) of dipleg(s). Such a non-top dipleg entrance seal pot may also provide for a reduced angle between the dipleg and the seal pot entrance (e.g., between the dipleg and the side of the seal pot) relative to the corresponding angle (i.e. between the dipleg and the top of the seal pot) in conventional designs.

As discussed in detail hereinbelow, according to embodiments of this disclosure, a seal pot according to this disclosure may be a non-circular design, in which the cross section of the seal pot is not round or is not substantially round. That is, in embodiments, a seal pot according to this disclosure does not have a substantially circular cross section. In embodiments, a seal pot according to this disclosure has a substantially rectangular cross section.

Although described hereinbelow with regard to dual fluidized bed indirect gasification, it is to be understood that the disclosed seal pots may be suitable for use in other applications to enable the operation of (at least) dual reactors at a pressure differential.

Seal Pot Configured for Side Dipleg Entry.

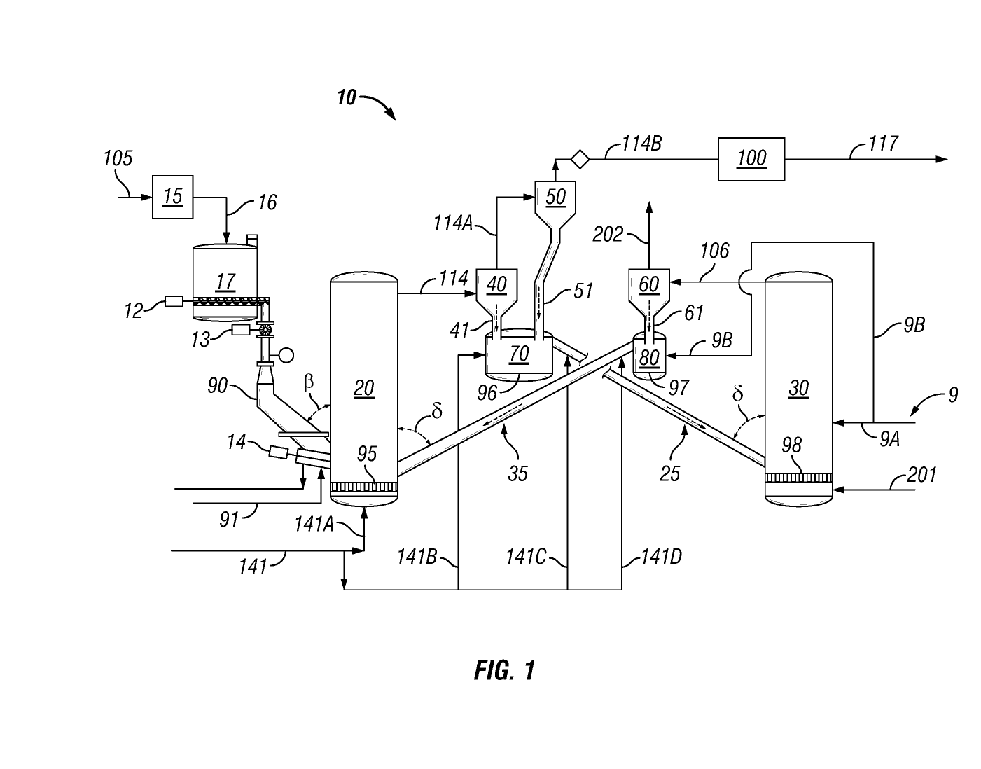

In embodiments, a seal pot of this disclosure is utilized in a DFB gasifier. Suitable DFB gasifiers are known in the art. Details of a DFB gasification system into which the herein disclosed seal pot may be incorporated are provided in U.S. Pat. App. No. 61/551,582, filed Oct. 26, 2011, and in U.S. patent application Ser. No. 13/355,732, filed Jul. 23, 2012, the disclosures of each of which are hereby incorporated herein for all purposes not contrary to this disclosure. FIG. 1 is a schematic of a dual fluidized bed gasifier 10 according to this disclosure. A dual fluidized bed gasifier enables the production of gas by use of a pyrolyzer or ‘gasifier’ 20 (e.g., a high throughput pyrolyzer) and an external combustor 30 fluidly connected via transfer lines 25 and 35, whereby a heat transfer material may be circulated therebetween to provide heat from combustion occurring in combustor 30 for the endothermic gasification reactions occurring in pyrolyzer 20. Via dual fluidized bed gasification, exothermic combustion reactions are separated from endothermic gasification reactions. The exothermic combustion reactions take place in or near combustor 30, while the endothermic gasification reactions take place in the gasifier/pyrolyzer 20. Separation of endothermic and exothermic processes may provide a high energy density product gas without the nitrogen dilution present in conventional air-blown gasification systems. For operation of DFB 10 with a differential pressure between pyrolyzer 20 and combustor 30, transfer lines 25 and 35 are sealed to maintain the desired pressure differential and prevent undesirable backflow of materials. One or more seal pots according to this disclosure, and described further hereinbelow, may be utilized to seal one or more of the transfer lines 25, 35.

In the embodiment of FIG. 1, dual fluidized bed gasification system 10 comprises combustor seal pot 70 configured to seal transfer line 25 and prevent backflow of materials from combustor 30 to pyrolyzer 20 (specifically to prevent backflow of materials from combustor 30 into one or more gasifier separators 40 and/or 50 upstream of combustor seal pot 70); and gasifier seal pot 80 configured to seal transfer line 35 and prevent backflow of materials from pyrolyzer 20 to combustor 30 (specifically to prevent backflow of materials from pyrolyzer 20 to one or more combustor separators 60 upstream of gasifier seal pot 80). Combustor seal pot 70 is fluidly connected with gasifier 20 via one or more primary gasifier separators 40 and/or one or more secondary gasifier separators 50, and gasifier seal pot 80 is fluidly connected with combustor 30 via one or more combustor separators 60. In the embodiment of FIG. 1, combustor seal pot 70 is fluidly connected with pyrolyzer 20 via one or more primary gasifier separators 40 and one or more secondary gasifier separators 50, while gasifier seal pot 80 is fluidly connected with combustor 30 via one or more combustor separators 60. Dual fluidized bed gasification system 10 may further comprise feedstock handling apparatus. For example, in the embodiment of FIG. 1, system 10 comprises a dryer 15 fluidly connected with gasifier feed line 105 and with a feed bin 17 via a line 16, feed bin auger 12, flow valve 13, gasifier feed inlet line 90, and gasifier feed auger 14. Downstream processing apparatus 100 is configured to utilize the gasifier product gas extracted from DFB gasifier via line 114B to provide downstream product, which is extractable from downstream processing apparatus 100 via product line 117. Such downstream processing apparatus 100 includes, but is not limited to, Fischer-Tropsch synthesis apparatus, non-FT chemical synthesis apparatus, power production apparatus, etc., are indicated in FIG. 1.

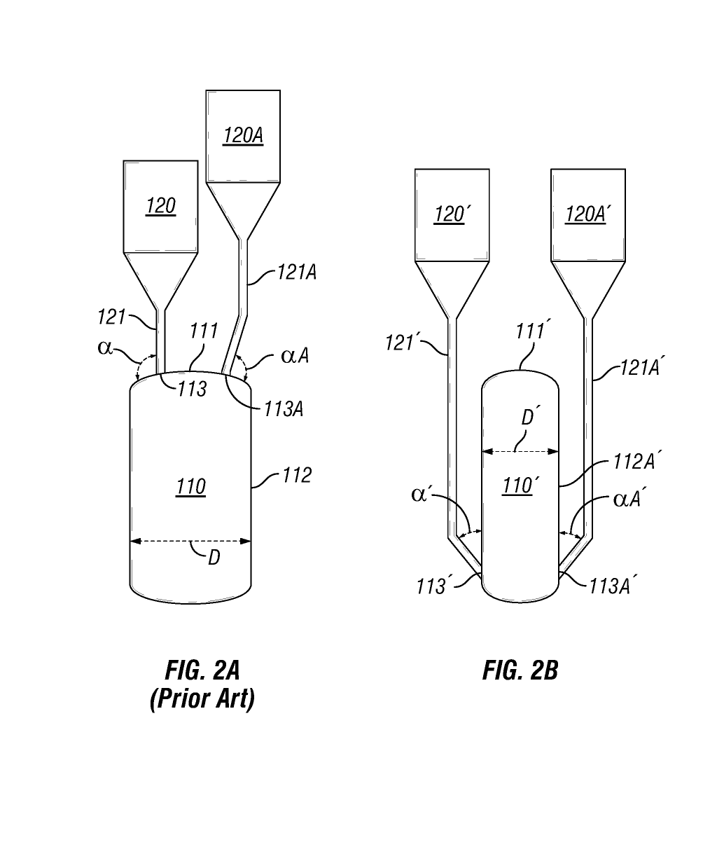

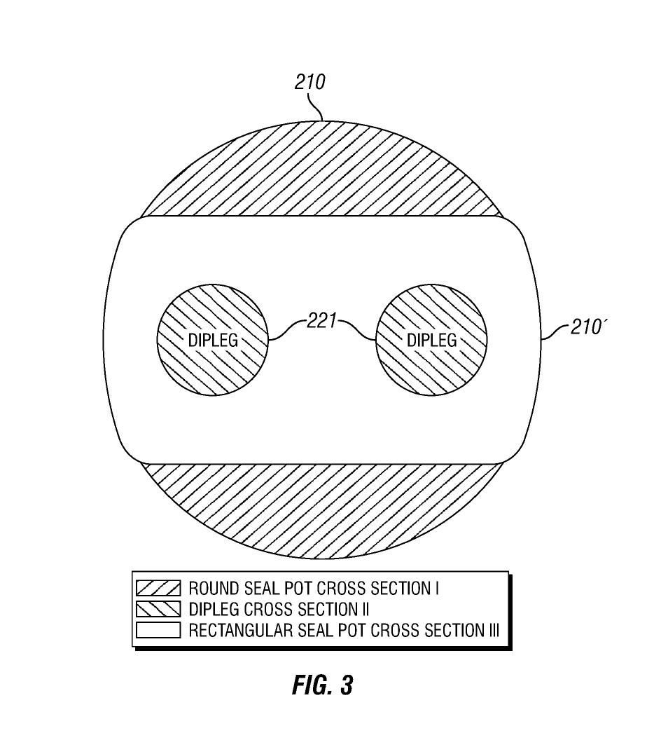

Description of seal pots according to this disclosure will now be provided with reference to FIGS. 2A, 2B, and 3. Description of suitable components (i.e. gasifier 20, combustor 30, gasifier separator(s) 40/50, combustor separator(s) 60, and dryer 15) of a dual fluidized system comprising at least one seal pot according to this disclosure will be provided hereinbelow. Seal pots designed as herein disclosed may be utilized as combustor seal pot (unit 70 in the embodiment of FIG. 1), as gasifier seal pot (unit 80 of FIG. 1), or both. As described in detail hereinbelow, a system incorporating a seal pot according to this disclosure may comprise any number of separators. For example, a seal pot according to this disclosure may be utilized as a combustor seal pot 70 and may be fluidly connected with gasifier 20 via one or more primary gasifier separators 40 (via gasifier product gas line 114 and primary gasifier separator(s) dipleg(s) 41) and optionally one or more secondary gasifier separators 50 (via primary gasifier separator gas outlet line 114A and secondary gasifier separator(s) dipleg(s) 51). Similarly, in embodiments, a seal pot according to this disclosure is utilized as a gasifier seal pot 80 and may be fluidly connected with combustor 30 via one or more combustor separator(s) 60 (via combustion flue gas outlet line 106 and combustor separator(s) dipleg(s) 61). As described in detail hereinbelow, the separators may be cyclone separators, as depicted in FIGS. 2A and 2B, or may be any other gas/solid separator known to those of skill in the art to be suitable for the separation of solids from a gas in which the solids are entrained; and connectable to a seal pot via a solids return line.

FIG. 2A is schematic of a prior art seal pot 110. In conventional seal pot designs, the diplegs (or ‘dip tubes’) from each of one or more upstream separators enter via the top of the seal pot. In the prior art embodiment of FIG. 2A, dipleg or ‘solids return line’ 121 from a first separator 120 and dipleg or ‘solids return line’ 121A of a second separator 120A enter seal pot 110 via the top 111 thereof. FIG. 2B is a schematic of a seal pot 110′ according to an embodiment of this disclosure. According to an embodiment of this disclosure, the dipleg from at least one of or more upstream separators does not enter via the top of the seal pot. In the embodiment of FIG. 2B, which corresponds to an embodiment of this disclosure, dipleg or ‘solids return line’ 121′ of a first separator 120′ and dipleg or ‘solids return line’ 121A′ of a second separator 120A′ do not enter seal pot 110′ via the top 111′ thereof, but rather enter seal pot 110′ via side 112′ thereof. As described in further detail hereinbelow, the disclosed seal pot having at least one dipleg or ‘solids return’ entrance at a location other than the top of the seal pot may be utilized, in a DFB gasification system, as combustor seal pot, gasifier seal pot, or both.

Although not indicated in FIGS. 2A and 2B, as discussed further hereinbelow, the diplegs may extend a distance into the seal pot and be separated from each other and/or from the seal pot refractory via a specified distance.

The minimum diameter or cross section of the seal pot depends on the number and size of the penetrations 113 or openings of the seal pot via which the diplegs enter the seal pot. That is, the size of the seal pot depends on the number of solids return lines (i.e. diplegs) that return solids from the upstream separator(s) to the seal pot. For example, the greater the number of cyclones associated with a seal pot (e.g., aligned in parallel and/or in series), the larger the seal pot diameter is required for conventional top-entry seal pot designs. Indeed, for applications incorporating a single separator (e.g., a single cyclone), upstream of the seal, adequate seal may be provided by an “L” valve or a “J” valve. Although an “L” valve or a “J” valve may provide an adequate seal, a seal pot may provide a more reliable seal, thus allowing for steadier circulation of heat transfer media (also referred to herein as a “heat transfer material” or “HTM”) and easier operation. Incorporation of one or more seal pot according to this disclosure into a DFB gasifier may enable steady state operation, reducing and/or eliminating undesirable unit pressure swings. Conventionally, the more diplegs and/or the larger the dipleg size (i.e. the larger the required penetration), the larger the diameter of the seal pot. Another factor upon which sealing design and stackup depend is the differential pressure between the gasifier 20 and the combustor 30 of the DFB gasifier. The height of heat transfer media required to provide the seal (and a desired safety factor) depends on the differential pressure between the two vessels (i.e. pyrolyzer 20 and combustor 30) of the dual fluidized bed gasification unit.

Larger seal pots are generally more expensive to fabricate. Smaller seal pots may weigh less (i.e. reduced metal of fabrication, reduced refractory lining, and/or reduced amount of heat transfer media therein during operation), resulting in a lighter operational vessel weight and thus reduced strength requirements for any support structure configured to support the seal pot. Additionally, due to the need for an increased volume of fluidization media to fluidize a larger seal pot, larger seal pots may be more expensive to operate. Also, utilization of more fluidization gas may adversely alter the composition of the resultant gas (i.e. the composition of the flue gas from the combustor or the gasification product gas (i.e. synthesis gas) from the gasifier. Thus, the disclosed seal pot, which may provide adequate seal with a smaller vessel relative to prior art seal pots, may be desirable for a number of these reasons.

In embodiments, a seal pot designed according to this disclosure in which top entry is not utilized for at least one dipleg enables a reduction in the size of the seal pot. In embodiments, utilization of a seal pot configured for non-top entrance of at least one dipleg enables a reduction in the width of the seal pot relative to conventional top entry designs. In embodiments, utilization of a seal pot configured for non-top entrance of at least one dipleg enables a reduction in the diameter of the seal pot relative to conventional top entry designs. For example, in the embodiment of FIG. 2B, the diameter D′ of seal pot 110′ according to this disclosure is reduced relative to the diameter D of the prior art seal pot 110 of FIG. 2A. This reduction in diameter of the herein disclosed device is enabled by the positioning of dipleg openings or penetrations 113′ and 113A′ on the side 112′ of seal pot 110′ in the embodiment of FIG. 2B, as opposed to the conventional positioning of dipleg openings 113 and 113A on the top 111 of prior art seal pot 110 of FIG. 2A. In embodiments, a seal pot is fluidly connected with at least two diplegs and is configured for side entrance of at least one of the at least two diplegs. In embodiments, a seal pot is fluidly connected with at least three diplegs and is configured for side entrance of at least one, two, or three of the at least three diplegs. In embodiments, a seal pot is fluidly connected with at least four diplegs and is configured for side entrance of at least one, two, three, or four of the at least four diplegs. In embodiments, a seal pot is fluidly connected with two diplegs and the seal pot is configured for side entrance of both of the diplegs. In embodiments, a seal pot is fluidly connected with two, three, or four diplegs and the seal pot is configured for top entrance of at least one of the diplegs and side entrance of at least one of the other diplegs.

As indicated in the embodiments of FIGS. 2A and 2B, utilization of side entrance for the diplegs may also reduce the angle between the seal pot entrance surface (i.e. top or side, respectively) and the dipleg. For example, conventional angles between the top 111 of the seal pot and the dipleg (angle α between separator 120 and seal pot 110 and angle αA between separator 120A and seal pot 110) may be greater than 45°. Desirably, utilization of side entry enables a reduction of the entry angle to less than or equal to about 45°, 40°, 35° or 30°, such that material freely flows from the seal pot back to the downstream vessel with which it is connected (i.e. the gasifier for a gasifier seal pot or the combustor for a combustor seal pot). If the entry angle is greater than the free flow angle at which material freely flows from the seal pot to the downstream vessel, additional fluidization may be utilized to ensure continuous circulation of heat transfer media. In embodiments, the entry angle α′/αA′ between the seal pot 110′ and the dipleg 120′/120A′ of a seal pot according to this disclosure is less than or equal to about 45°. The non-top entry penetrations or openings 113′/113A′ of the disclosed seal pot may be elliptical in shape. In embodiments, penetrations or openings 113′/113A′ have a cross-sectional area at least as large (e.g., may be larger than) as the penetrations or openings 113/113A of prior art designs. In embodiments, an “L” valve design is incorporated into the dipleg in order to avoid the use of larger elliptical openings. The addition of an “L” valve design on the dipleg(s) may allow further reduction in the seal pot size (e.g., diameter or height, respectively, for round or cylindrical seal pots). The reduction in size can result from utilization of the “L” valve in conjunction with a smaller seal pot to provide part of the pressure seal that a larger seal pot would have provided.

Seal Pot Configured with Non-Circular Cross Section.

Also disclosed herein is a seal pot having a cross section that is not substantially circular. In embodiments, a seal pot according to this disclosure has a substantially rectangular cross section. In embodiments, a seal pot according to this disclosure has a substantially square cross section. In embodiments, a seal pot according to this disclosure has a substantially triangular cross section.

Such a seal pot having a non-circular cross section may be particularly desirable in low pressure applications. In embodiments, the operating pressure of the seal pot is less than about 25 psig, 20 psig, or 15 psig, and the seal pots do not have a circular or substantially circular cross section. The use of seal pots having a cross sectional shape other than round (e.g., substantially square or rectangular) may be employed in smaller applications in which there are fewer separators (e.g., cyclones) associated with the seal pot. Such smaller applications may include gasifier throughputs of less than 300, less than 200, less than 100, or less than 100 DTPD (dry tons per day). The use of a seal pot with a non-circular cross section may be employed in applications in which the pressure differential between the gasifier and the combustor is relatively low, i.e. less than about 25 psig, 20 psig, or 15 psig. In smaller dual fluidization bed indirect gasifiers, fewer cyclones may be utilized (e.g., in series and/or in parallel as further discussed hereinbelow) to effect solids separation from the gasification product gas (i.e. from the product synthesis gas exiting gasifier 20 via gasifier product gas outlet line 114 and/or primary gasifier separator gas outlet line 114a) and/or from the flue gas exiting the combustor 30 via combustor flue gas outlet line 106. As the number of seal pot penetrations is reduced, a seal pot having a round cross section may be larger than required, and thus require the use of more seal pot fluidization media (e.g., steam) to circulate the increased volume of heat transfer media (HTM) therein than a seal pot as disclosed herein, having a non-circular cross section. Utilizing the disclosed non-circular cross sectioned seal pot may allow for maintenance of a desired separation between diplegs extending within the seal pot (and/or between the dipleg penetrations), while reducing the cross sectional area of the seal pot and thus concomitantly reducing the amount of fluidization media required to fluidize the contents of the seal pot. In embodiments, the operating pressure of the gasifier and the combustor are close to atmospheric, and at least one seal pot (i.e. at least one gasifier and/or combustor seal pot) has a non-circular cross section. Smaller scale or smaller application dual fluidized bed indirect gasifiers, i.e. DFB gasifiers configured for less than 300 DTPD (e.g., configured for less than 300, 200, 100 or 50 dry tons per day (DTPD)) are generally operable at lower pressures than larger scale/larger application units, i.e. DFB gasifiers configured for more than 300 DTPD (e.g., configured for more than 300, 400, 500, 1000, or 2000 dry tons per day (DTPD)).

FIG. 3 depicts a cross section 210′ of a seal pot designed according to this disclosure. As indicated in the embodiment of FIG. 3, in order to provide the same spacing between diplegs 221 (the penetration or openings of diplegs 221 are indicated by hatch lines II in FIG. 3), a seal pot having circular cross-section 210 has a cross sectional area that is larger by the area indicated by hatch lines I than the rectangular cross sectional area of seal pot 210′, which rectangular cross section is indicated by non-hatched section III. In a similar manner, it is envisaged that a seal pot having a square or rectangular cross section may be desirable for smaller (i.e. lower throughput) and/or lower pressure applications (e.g., of less than or equal to 25, 20, or 15 psig) in which a seal pot is utilized with an even number of diplegs, e.g., two or four penetrations, while a seal pot having a substantially triangular or rectangular cross sectional area may be desirable for smaller and/or reduced pressure applications in which a seal pot is utilized with three diplegs (i.e. three penetrations). Seal pots having other cross sectional shapes may be feasible as well, although manufacture of such a seal pot may incur more cost than justified by the potentially smaller size thereof. A seal pot according to this disclosure may have corners that make a 90 degree angle or, as indicated in the embodiment of FIG. 3, may have rounded corners.

The smaller size (i.e. smaller cross-sectional area) of the disclosed seal pot design may enable the utilization of the seal pot with a reduced amount (e.g., a reduced fluidization gas flow rate) of fluidization gas (e.g., steam, air, or alternate fluidization gas as described in U.S. Pat. App. No. 61/551,582, filed Oct. 26, 2011) than a conventional seal pot having a circular cross sectional area, while providing equivalent seal (e.g., between a gasifier 20 and a combustor 30). In embodiments, utilization of a disclosed seal pot having a non-circular cross section reduces the amount of steam utilized as seal pot fluidization gas. In this manner, more steam may be available for export and/or less steam produced/utilized, thus reducing operating expenses and/or increasing profits for the DFB indirect gasifier. Additionally, utilization of less fluidization gas in the seal pot may result in a reduction in the amount of said fluidization gas (e.g., steam) winding up in the product gasification gas stream. Reducing the amount of fluidization gas in the synthesis gas product will increase, on a wet basis, the BTU/scf (standard cubic foot) of the product gasification gas. As mentioned hereinabove, utilization of a seal pot having a non-circular cross section may enable the use of a smaller seal pot requiring a reduced amount of heat transfer material therein, and thus allowing an overall reduction in the amount of heat transfer material utilized in the DFB indirect gasification system 10. As the cost of the heat transfer material can be substantial, this may be a significant benefit of using a seal pot designed with a non-circular cross section. Additional or alternative potential benefits of using a seal pot with a non-circular cross section may include an increase in the efficiency of DFB indirect gasification system 10 due to reduced heat loss (because of a reduction in the surface area of the seal pot), reduced steam usage for fluidization (and thus a reduced usage of boiler feed water and associated costs), and, in certain applications, reduced generation of waste water, potentially with a concomitant reduction in waste water treatment costs.

It is also noted that a smaller seal pot design (i.e. smaller cross sectional area) provided by the non-circular seal pot designs disclosed herein may also enable incorporation of a smaller and/or simpler seal pot fluidization distributor (96 in FIG. 1 for CSP, 97 for GSP).

Dual Fluidized Bed Indirect Gasifier.

As mentioned hereinabove, the disclosed seal pots may be suitable for use in any application in which two fluidly connected vessels are operated at a differential pressure. In embodiments, at least one seal pot as disclosed herein may be incorporated into a dual fluidized bed gasifier. As described above, a DFB system 10 which may incorporate a combustor seal pot 70, a gasifier seal pot 80, or both, designed according to this disclosure, is depicted in FIG. 1, which is a schematic of a dual fluidized bed gasification system 10, according to an embodiment of this disclosure. Embodiments of DFB system 10, including a description of suitable components thereof, will now be described in further detail. DFB system 10 of FIG. 1 comprises gasifier 20, combustor 30, combustor seal pot 70, gasifier seal pot 80, primary gasifier separators 40, secondary gasifier separators 50, and combustor separators 60. Combustor seal pot 70 is fluidly connected with pyrolyzer 20 via one or more gasifier separators 40 (e.g., one or more heat transfer material gasifier cyclone), secondary gasifier separator 50 (e.g., one or more ash cyclone), combustor separators 60 (e.g., primary and/or secondary combustor cyclones). The DFB indirect gasifier may operate by introducing gasifier fluidization gas via line 141/141A at a low gas velocity to fluidize a high average density bed in a gasifier/pyrolysis vessel. The high average density bed may comprise a relatively dense fluidized bed in a lower region thereof, the relatively dense fluidized bed containing a circulating, heated, relatively fine and inert particulate heat transfer material. Carbonaceous material is introduced into the lower region of the pyrolyzer at a relatively high rate and endothermal pyrolysis of the carbonaceous material is accomplished by means of a circulating, heated, inert material, producing a gasifier product gas comprising synthesis gas (i.e. comprising hydrogen and carbon monoxide). In embodiments, in an upper region of the pyrolyzer is a lower average density entrained space region containing an entrained mixture comprising inert solid, particulate heat transfer material, char, unreacted carbonaceous material and product gas. The entrained mixture is removed from the gasifier to one or more separators, such as a cyclone, wherein solids (heat transfer particles, char and/or unreacted carbonaceous material) are separated from the gasification product gas. At least a portion of the removed solids is returned to the pyrolyzer after reheating to a desired temperature via passage through an exothermic reaction zone of an external combustor.

As depicted in FIG. 1, DFB indirect gasifier 10 comprises gasifier 20 (also referred to herein as a ‘pyrolyzer’) that is fluidly connected with combustor 30, whereby heat lost during endothermic gasification in gasifier/pyrolyzer 20 can be supplied via exothermic combustion in combustor 30, as discussed hereinabove. DFB indirect gasifier 10 further comprises at least one combustor seal pot 70 and at least one gasifier seal pot 80. Pyrolyzer 20 is operable for removal therefrom of a circulating particulate phase and char by entrainment in gasifier product gas. Separation of solid, entrained particulates comprising particulate heat transfer material and char from the gasification product gas, can be accomplished by gas/solid separators, such as conventional cyclone(s). In embodiments, substantially all system solids are elutriated despite the use of what are generally considered to be low inlet gasifier fluidization gas velocities. The DFB indirect gasifier thus further comprises one or more gasifier particulate separator (e.g., one or more gasifier cyclones) and one or more combustor particulate separator (e.g., one or more combustor cyclones). In the embodiment of FIG. 1, DFB indirect gasifier 10 comprises primary gasifier cyclones 40, secondary gasifier cyclones 50, and combustor cyclones 60.

Circulating between gasifier 20 and combustor 30 is a heat transfer material (HTM). The HTM may be introduced, for example via lines 9, 9A (directly to the combustor), and/or 9B (directly to the gasifier seal pot, optionally with gasifier seal pot fluidization gas). The heat transfer material is relatively inert compared to the carbonaceous feed material being gasified. In embodiments, the heat transfer material is selected from the group consisting of sand, limestone, and other calcites or oxides such as iron oxide, olivine, magnesia (MgO), attrition resistant alumina, carbides, silica aluminas, attrition resistant zeolites, and combinations thereof. The heat transfer material is heated by passage through an exothermic reaction zone of an external combustor. In embodiments, the heat transfer material may participate as a reactant or catalytic agent, thus ‘relatively inert’ as used herein with reference to the heat transfer material is as a comparison to the carbonaceous materials and is not used herein in a strict sense. For example, in coal gasification, limestone may serve as a means for capturing sulfur to reduce sulfate emissions. Similarly, limestone may serve to catalytically crack tar in the gasifier. In embodiments, the gasifier may be considered a catalytic gasifier, and a catalyst may be introduced with or as a component of the particulate heat transfer material. For example, in embodiments, a nickel catalyst is introduced along with other heat transfer material (e.g., olivine or other heat transfer material) to promote reforming of tars, thus generating a ‘clean’ synthesis gas that exits the gasifier. The clean synthesis gas may be an essentially tar-free synthesis gas. In embodiments, an amount of nickel catalyst (e.g., about 5, 10, 15, or 20 weight percent nickel) is circulated along with other heat transfer materials.

The heat transfer material may have an average particle size in the range of from about 1 μm to about 10 mm, from about 1 μm to about 1 mm, or from about 5 μm to about 300 μm. The heat transfer material may have an average density in the range of from about 50 lb/ft³ (0.8 g/cm³) to about 500 lb/ft³ (8 g/cm³), from about 50 lb/ft³ (0.8 g/cm³) to about 300 lb/ft³ (4.8 g/cm³), or from about 100 lb/ft³ (1.6 g/cm³) to about 300 lb/ft³ (4.8 g/cm³).

In embodiments, equilibrium is pushed toward the formation of hydrogen and carbon monoxide during pyrolysis via, for example, the incorporation of a material that effectively removes carbon dioxide. For example, NaOH may be introduced into DFB indirect gasifier 10 (e.g., with or to the heat transfer material, to gasifier 20, to combustor 30, or elsewhere) to produce Na₂CO₃, and/or CaO injection may be utilized to absorb CO₂, forming CaCO₃, which may be separated into CO₂ and CaO which may be recycled into DFB indirect gasifier 10. The NaOH and/or CaO may be injected into gasifier or pyrolyzer 20. Addition of such carbon dioxide-reducing material may serve to increase the amount of synthesis gas produced (and thus available for downstream processes such as, without limitation, Fischer-Tropsch synthesis and non-Fischer-Tropsch chemical and/or fuel production) and/or may serve to increase the Wobbe number of the gasification product gas for downstream power production. Such or further additional materials may also be utilized to adjust the ash fusion temperature of the carbonaceous feed materials within the gasifier. As with the optional carbon dioxide-reducing materials, such ash fusion adjustment material(s) may be incorporated via addition with or to the feed, with or to the heat transfer media, to gasifier 20, to combustor 30, and/or elsewhere. In embodiments, the additional material(s) are added with or to the feed to the gasifier. In embodiments, the additional material(s) are added with or to the heat transfer media.

Pyrolyzer 20 is a reactor comprising a fluid-bed of heat transfer material at the reactor base, and is operated at feed rates sufficiently high to generate enough gasifier product gas to promote circulation of heat transfer material and gasified char, for example, by entrainment. The gasifier may be a hybrid with an entrained zone above a fluidized bed gasifier, as described in U.S. Pat. No. 4,828,581, which is hereby incorporated herein by reference in its entirety for all purposes not contrary to this disclosure.

In embodiments, gasifier/pyrolyzer 20 is an annular shaped vessel comprising a conventional gas distribution plate 95 near the bottom, and comprising inlets for feed material(s), heat transfer material(s), and fluidizing gas. The gasifier vessel comprises an exit at or near the top thereof and is fluidly connected thereby to one or more separators from which gasification product gas is discharged and solids are recycled to the bottom of the gasifier via an external, exothermic combustor operable to reheat the separated, heat transfer material. The gasifier operates with a recirculating particulate phase (heat transfer material), and at inlet gas velocities in the range sufficient to fluidize the heat transfer material, as further discussed hereinbelow.

Referring again to FIG. 1, the angle δ between the seal pot and the vessel (i.e. between combustor seal pot 70 and combustor 30 and/or between gasifier seal pot 80 and gasifier 20) may be in the range of from about 5 to about 90°, from about 5 to about 80°, or from about 5 to about 60°. In embodiments, δ is less than 45°. Utilization of a higher δ generally mandates a taller seal pot. Lower angles may be operable with the use of fluidization/aeration to maintain fluidization. Generally, for δ angles between 5 and about 45 degrees, fluidization/aeration may also be utilized. In embodiments, a lower angle, such as an angle of about 5 degrees, is utilized in the design so that the seal pot (CSP 70 and/or GSP 80) is relatively short and the overall height of the unit (i.e. the stackup) may be reduced.

As indicated in the embodiment of FIG. 1, the inlets for feed (via feed chute 90) and recirculating heat transfer material (via heat transfer line 35) are located at or near the base of gasifier 20, and may be proximate the pyrolyzer gas distributor 95. Without limitation, the carbonaceous feedstock may comprise shredded bark, wood chips, sawdust, sludges (e.g., sewage sludge), municipal solid waste (MSW), RDF, other biomass, methane, coal, Fischer-Tropsch synthesis products, spent Fischer-Tropsch catalyst/wax, or a combination thereof. In embodiments, the carbonaceous feedstock comprises biomass. It is envisaged that coal may be added to gasifier 20, depending on the ash fusion temperature. Refinery tank bottoms, heavy fuel oil, etc., which may, in embodiments, be contaminated with small solids may be introduced into the gasifier and/or the combustor, so long as the ash fusion temperature therein is not adversely affected. In embodiments, petcoke is ground to a size in the range suitable to ensure volatilization within the pyrolyzer. In embodiments, petcoke is introduced into the pyrolyzer as a component of the carbonaceous feedstock. In embodiments, Fischer-Tropsch synthesis products (e.g., Fischer-Tropsch wax) and/or spent catalyst (e.g., recycled spent catalyst in product wax) are produced from at least a portion of the gasification product gas in downstream Fischer-Tropsch synthesis, and a portion of the Fischer-Tropsch product(s) (e.g., spent Fischer-Tropsch wax) that will crack under the operating conditions therein is recycled as feed/fuel to gasifier 20.

The carbonaceous gasifier feedstock may be introduced to pyrolyzer 20 via any suitable means known to one of skill in the art. The feed may be fed to the gasifier using a water cooled rotary screw 13 and/or a feed auger 14. The feed may be substantially solid and may be fed utilizing a screw feeder or a ram system. In embodiments, the feed is introduced into the gasifier as a solid. In embodiments, dual feed screws are utilized and operation is alternated therebetween, thus ensuring continuous feeding.

As indicated in FIG. 1, a gasifier feed inlet line or chute 90 may be configured to provide an angle β between the feed inlet line 90 and gasifier vessel 20. The feed inlet angle β may be in the range of from about 5 to about 35 degrees, from about 5 to about 25 degrees, or from about 5 to about 15 degrees, such that the feed flows substantially uniformly into (i.e. across the cross section thereof) of pyrolyzer 20. In this manner, feed isn't limited to one side of the pyrolyzer, for example. A purge gas may also be introduced with the feed, e.g., via purge gas line 91 from a lockhopper or rotary valve) via the feed chute 90 to maintain a desired pressure and/or to aid in feeding the feed to the pyrolyzer. In embodiments, the purge gas is selected from the group consisting of carbon dioxide, steam, fuel gas, nitrogen, synthesis gas, flue gas from the combustor (e.g., in flue gas line 202), and combinations thereof. In embodiments, the purge gas comprises nitrogen. In embodiments, the feed is not purged. If CO₂ recovery is present, for example downstream, it may be desirable for the feed purge gas to be or to comprise carbon dioxide.

In embodiments, the gasifier feed is pressurized. The carbonaceous feed material may be fed to the gasifier at a pressure in the range of from about 0 to about 40 psig. A dryer 15 may be utilized to dry the feed and/or may be operated at a pressure, thus providing the feed material to the gasifier at a desired pressure and/or moisture content. The feed may be dried prior to introduction into gasifier 20 via feed bin 17 and inlet line 90, and/or may be introduced hot (e.g., at a temperature of greater than room temperature). In embodiments, the feed is cold (e.g., at a temperature of less than or about equal to room temperature). The feed may be introduced into the gasifier via feed bin 17, for example, at a temperature in the range of from about −40 to about 260° F. In embodiments, the feed is at a temperature in the range of from −40 to about 250° F. In embodiments, the feed is at ambient temperature. In embodiments, the feed is at room temperature. In embodiments, a feed material is comminuted prior to introduction into the gasifier. In embodiments, a feed material is preheated and/or comminuted (e.g., chipped) prior to introduction into the gasifier. Feed bin 17 may be operable as a dryer, as disclosed in U.S. Pat. App. No. 61/551,582, filed Oct. 26, 2011.

In embodiments, the moisture content of the pyrolyzer feed is in the range of from about 5% to about 60%. In embodiments, the pyrolyzer feed has a moisture content of greater than about 10, 20, 30, or 40 wt %. In embodiments, the pyrolyzer feed has a moisture content of less than about 10, 20, 30, or 40 wt %. In embodiments, the moisture content of the pyrolyzer feed is in the range of from about 20 to about 30 wt %. In embodiments, the moisture content of the pyrolyzer feed is in the range of from about 20 to about 25 wt %.

In embodiments, more drying of the feed material may be desired/utilized to provide syngas (via, for example, feed drying, gasification and/or partial oxidation) at a molar ratio of H₂/CO suitable for downstream Fischer-Tropsch synthesis in the presence of an iron catalyst (i.e. for which a molar ratio of hydrogen to carbon monoxide of about 1:1 is generally desirable). In embodiments, less drying may be desired/utilized, for example, to provide a synthesis gas having a molar ratio of H₂/CO suitable for downstream Fischer-Tropsch synthesis in the presence of a cobalt catalyst (i.e. for which a molar ratio of hydrogen to carbon monoxide of about 2:1 is generally desirable). In embodiments, at least a portion, of the hot combustor flue gas (described further hereinbelow) is utilized to dry a gasifier feed prior to introduction into gasifier 20. In embodiments, substantially all of the hot combustor flue gas (described further hereinbelow) is utilized to dry a gasifier feed prior to introduction into gasifier 20.

In embodiments, the feed rate (flux) of carbonaceous material to the gasifier is greater than or equal to about 2000, 2500, 3000, 3400, 3500, lb/h/ft², 4000, or 4200 lb/h/ft². The design may allow for a superficial velocity at the outlet (top) of the gasifier in the range of 20-45 ft/s, 30-45 ft/s, or 40-45 ft/s (assuming a certain carbon conversion/volatilization/expansion). In embodiments, the carbon conversion is in the range of from about 0 to about 100%. In embodiments, the carbon conversion is in the range of from about 30 to about 80%. The gasifier vessel size, e.g., the diameter thereof, may be selected based on a desired outlet velocity.

Gasifier fluidization gas may be fed to the bottom of gasifier 20 (for example, via a distributor) at a superficial velocity in the range of from about 0.5 ft/s to about 10 ft/s, from about 0.8 ft/s to about 8 ft/s, or from about 0.8 ft/s to about 7 ft/s. In embodiments, the pyrolyzer fluidization gas (e.g., steam and/or alternate fluidization gas) inlet velocity is greater than, less than, or equal to about 1, 2, 3, 4, 5, 6, 7 or 8 ft/s. In embodiments, a gasifier fluidization gas superficial velocity of at least or about 5, 6, 7, or 8 ft/s is utilized during startup.

The fluidization gas introduced into gasifier 20 via lines 141/141a may be selected, without limitation, from the group consisting of steam, flue gas, synthesis gas, LP fuel gas, tailgas (e.g., Fischer-Tropsch tailgas, upgrader tailgas, VSA tailgas, and/or PSA tailgas) and combinations thereof. In embodiments, the gasifier fluidization gas comprises Fischer-Tropsch tailgas. In embodiments, the gasifier fluidization gas comprises upgrader tailgas. By utilizing upgrader tailgas, additional sulfur removal may be effected, as the upgrader tailgas may comprise sulfur.

In embodiments, the pyrolyzer fluidization gas comprises PSA tailgas. Such embodiments may provide substantial hydrogen in the gasifier product gas, and may be most suitable for subsequent utilization of the product gas in downstream processes for which higher molar ratios of hydrogen to carbon monoxide are desirable. For example, higher molar ratios of hydrogen to carbon monoxide may be desirable for downstream processes such as a nickel dual fluidized bed gasification (e.g., for which H₂/CO molar ratios in the range of from about 1.8:1 to about 2:1 may be desired). Such a dual fluidized bed (DFB) indirect gasifier is disclosed, for example, in U.S. patent application Ser. No. 12/691,297 (now U.S. Pat. No. 8,241,523) filed Jan. 21, 2010, the disclosure of which is hereby incorporated herein for all purposes not contrary to this disclosure. Utilization of PSA tailgas for gasifier fluidization gas may be less desirable for subsequent utilization of the gas for POx (for which H₂/CO molar ratios closer to or about 1:1 may be more suited), as the hydrogen may be undesirably high. In embodiments, the gasification product gas is at a moisture content of less than a desired amount (e.g., less than about 10, 11, 12, 13, 14, or 15 percent) in order to provide a suitable composition (e.g., H₂/CO molar ratio) for downstream processing (e.g., for downstream POx). In embodiments, a combination of feed drying, DFB indirect gasification and POx is utilized to provide a synthesis gas suitable for downstream Fischer-Tropsch synthesis utilizing a cobalt catalyst.

The temperature at or near the top of gasifier 20 (e.g., proximate entrained product removal therefrom) may be in the range of from about 1000° F. to about 1600° F., from about 1100° F. to about 1600° F., from about 1200° F. to about 1600° F., from about 1000° F. to about 1500° F., from about 1100° F. to about 1500° F., from about 1200° F. to about 1500° F., from about 1000° F. to about 1400° F., from about 1100° F. to about 1400° F., from about 1200° F. to about 1400° F., from about 1200° F. to about 1450° F., from about 1200° F. to about 1350° F., from about 1250° F. to about 1350° F., from about 1300° F. to about 1350° F., or about 1350° F.

In embodiments, the operating pressure of gasifier 20 is greater than about 2 psig. In embodiments, the gasifier pressure is less than or equal to about 45 psig. In embodiments, the gasifier pressure is in the range of from about 2 psig to about 45 psig.

Heat transfer material is introduced into a lower region of gasifier 20. The heat transfer material may be introduced approximately opposite introduction of the gasifier feed material. To maintain suitable flow, the HTM inlet may be at an angle δ in the range of from about 5 degrees to about 90 degrees, or at an angle δ of greater than or about 5, 10, 20, 30, 40, 50, or 60 degrees. The heated heat transfer material from combustor 30 may be introduced to gasifier 20 at a temperature in the range of from about 1400° F. to about 2000° F., from about 1450° F. to about 1900° F., from about 1400° F. to about 1600° F., from about 1450° F. to about 1600° F., from about 1525° F. to about 1875° F., or about 1550° F., 1600° F., 1700° F., or 1750° F.

In embodiments, the pyrolyzer comprises a gas distributor 95. In embodiments, the heat transfer material is introduced to pyrolyzer 20 at a location at least 4, 5, 6, 7, 8, 9 or 10 inches above pyrolyzer gas distributor 95. The heat transfer material may be introduced at a position in the range of from about 4 to about 10 inches, or from about 4 to about 6 inches above distributor 95. In embodiments, the distributor is operable to provide a gas flow rate of at least or about 4, 5, 6, 7, 8, 9, or 10 ft/s, for example, during startup. Gasifier distributor 95 (and/or a distributor 96 in a combustor seal pot 70, a distributor 97 in gasifier seal pot 80, and/or a distributor 98 in combustor 30) may comprise a ring distributor, a pipe distributor, a Christmas tree distributor, or other suitable distributor design known in the art. In embodiments, the distributor comprises a pipe distributor that may be loaded through a side of the vessel for ease of nozzle replacement thereon (generally suitable in embodiments in which the running pressure is less than 12 or 15 psig inclusive). Distributors with fewer inlets (e.g., Christmas tree distributors and/or ring distributors) may be more desirable for higher pressure applications.

In embodiments, the temperature differential between the gasifier and the combustor (i.e. T_{C}−T_{G}) is maintained at less than or equal to about 250° F., 260° F., 270° F., 280° F., 290° F., 300° F., 310° F., 320° F., 330° F., 340° F., or 350° F., or is maintained at a temperature within any range therebetween. If T_{C}−T_{G} is greater than about 300° F., sand or other heat transfer material may be added to DFB indirect gasifier 10.

As mentioned hereinabove, dual fluidized bed indirect gasifier 10 comprises one or more gas/solid separator (e.g., one or more cyclone) on the outlet of pyrolyzer 20. The system may comprise primary and/or secondary gasifier particulate separators (e.g., primary gasifier cyclone(s) 40 and/or secondary gasifier cyclone(s)) 50. In embodiments, the gasifier separators are operable/configured to provide a HTM removal efficiency of at least or about 98, 99, 99.9, or 99.99%. In embodiments, primary gasifier separators 40 are operable to remove at least or about 99.99% of the heat transfer material from a gas introduced thereto. Higher removal of heat transfer material is generally desirable, as the cost of makeup particulate heat transfer material and the cost of heating same to operating temperature are considerable. The secondary gasifier particulate separator(s) 50 (e.g., cyclones) may be configured to remove at least about 80, 85, 90 or 95% of the char (and/or ash) in the gasifier product gas introduced thereto. In embodiments, secondary gasifier separator(s) 50 are operable to remove at least about 95% of the ash and/or char introduced thereto. There may be some (desirably minimal) amount of recycle ash. The exit from the gasifier to the gasifier primary cyclones may comprise a 90 degree flange. The primary and/or secondary gasifier separators may comprise a solids return line (e.g., a dipleg(s) 41 and/or 51) configured for introduction of separated solids into combustor sealing apparatus 70, which may be a combustor seal pot according to this disclosure.

The product synthesis gas exiting the gasifier separators may be utilized for heat recovery in certain embodiments. In embodiments, the synthesis gas is not utilized for heat recovery prior to introduction into downstream conditioning apparatus configured to condition synthesis gas for use in Fischer-Tropsch synthesis and/or power production. In embodiments, the disclosed system further comprises a POx unit, a nickel dual fluidized bed gasifier, and/or a boiler downstream of the gasifier separator(s). It is envisaged that heat recovery apparatus may be positioned between primary and secondary separators. When utilized for heat recovery, the temperature of the synthesis gas may be maintained at a temperature of at least 600° F., at least 650° F., at least 700° F., at least 750° F. or at least 800° F. after heat recovery. For example, maintenance of a temperature of greater than 650° F., 700° F., 750° F., 800° F., 850° F., or 900° F. may be desirable when heat recovery is upstream of tar removal (for example, to prevent condensation of tars). In embodiments, the synthesis gas is maintained at a temperature in the range of from about 650° F. to about 800° F. during heat recovery. In embodiments, the system comprises a steam superheater and optionally there-following a waste heat boiler or waste heat superheater downstream of the gasifier separators for heat recovery from the hot gasification gas comprising syngas, and for the production of steam. In embodiments, the system comprises an air preheater for heat recovery from the hot flue gas or synthesis gas. In embodiments, the system comprises a boiler feedwater (BFW) preheater for heat recovery from the hot synthesis gas. The system may comprise an air preheater, (for example to preheat air for introduction into the combustor, as the introduction of hotter air into the combustor may be desirable). The system may comprise any other suitable apparatus known to those of skill in the art for heat recovery.

As noted hereinabove, DFB gasifier indirect 10 comprises a combustor 30 configured to heat the heat transfer material separated via one or more gasifier separators (e.g., cyclones) from the gasification product comprising entrained materials extracted from pyrolyzer 20. The combustor may be any type of combustor known in the art, such as, but without limitation, fluidized, entrained, and/or non-fluidized combustors.

Referring now to FIG. 1, combustor 30 is associated with a combustor sealing device 70, which may be a combustor seal pot (CSP) according to this disclosure, and one or more combustor cyclone 60 configured to remove particulates from the combustor flue gas. As discussed hereinabove, the combustor sealing apparatus is configured to prevent backflow of materials from the combustor into the gasifier cyclone(s) 40, 50.

In embodiments, air is fed into the bottom of combustor 30 via combustion air inlet line 201 and steam is fed into CSP 70 via line 141B, for example. The steam feed rate may be about 4000 lb/h (for a plant operating at about 500 dry tons/day, for example). The steam passes through and exits combustor cyclone 60. The cyclone efficiency is dramatically affected by the superficial velocity thereto. The higher the superficial velocity, the better the cyclone efficiency. If the ACFM (actual cubic feet per minute) can be reduced, the cyclone efficiency may be improved (based on more solids per cubic foot). In embodiments, combustion air is fed into CSP 70, rather than steam. The amount of combustion air required for the DFB indirect gasification depends on the amount of carbon introduced into combustor 30 via gasifier 20. The total volume of air introduced into combustor 30 is controlled to provide an acceptable level of excess oxygen in the flue gas. The acceptable level depends on downstream usage. For example, when a DFB of this disclosure is combined with a downstream nickel DFB, as mentioned hereinabove and disclosed in U.S. Pat. No. 8,241,523, a higher amount of excess oxygen in the flue gas may be desirable. In embodiments, 20-25% of the fluidization gas (e.g., air) for combustor 30 is introduced into or via CSP 70. In such embodiments, CSP 70 may be designed with additional insulation since the process side temperature will be higher with combustion air fluidization than steam fluidization and since partial combustion of the char will occur in the seal pot. In embodiments, combustion air, rather than steam, is fed into CSP 70, such that heat is not removed from combustor 30 due to the flow of steam therethrough, and the downstream combustor separator(s)/cyclone(s) 60 and/or the downstream gasifier 20 may be incrementally smaller in size. That is, the introduction of air (e.g., at about 1000° F.), rather than the introduction of (e.g., 550° F.) steam into CSP 70 (which is heated therein to, for example, about 1800° F.) may serve to reduce the amount of steam utilized in gasifier 10. This may allow the downstream vessel(s) to be smaller. When air is introduced into CSP 70, partial combustion of char may occur in the seal pot with air (rather than steam), and the downstream combustor cyclone 60 and/or gasifier 20 may be smaller. Accordingly, in embodiments the combustor is reduced in size by introduction of a portion of the combustor fluidization gas into CSP 70. For example, if the desired fluidization velocity at the top (e.g., proximate the flue gas exit) of the combustor is 30-35 ft/s, only about 75-80% (i.e. about 20 feet/s) may need to be introduced into the bottom of the combustor because 20-25% of the fluidization gas may be introduced into or via the CSP. Thus, the combustor size may be reduced. Another benefit of introducing combustor fluidization gas via the CSP is that the combustor cyclone(s) can be incrementally smaller or be operated more efficiently. Also, nitrogen in the air can be heated and thermal efficiency gained by eliminating or reducing the need for superheating steam (e.g., at 4000 lb/h of steam). (When steam is utilized, there may be a substantial loss of the steam. Very little heat may be recoverable therefrom, although the steam may flow through a downstream heat exchanger on, for example, the flue gas line.) As air has a lower heat capacity than steam, a higher unit efficiency may be obtained via usage of air as CSP fluidization gas and the gasification product gas may have a lower dew point, due to removal of steam from the system. Introducing combustion air as fluidization gas into CSP 70 may also reduce the need for and/or the size of a downstream boiler, due to a reduced amount of steam being introduced into DFB system 10. Thus, usage of combustion air rather than steam as CSP fluidization gas may result in savings of steam, boiler chemicals, water demand, and energy lost in the boiler blowdown and due to the differential heat capacity between steam and air.

Benefits of utilizing combustion air as fluidization gas for CSP 70 thus may include a reduction in unit steam consumption, increased unit efficiency due to elimination of heat losses due to heating of fluidization steam in the combustor loop, and increased unit efficiency due to increase in the temperature of the heat transfer material, which may translate into reduced gasifier feed usage.

In embodiments, the fluidization gas for one or more of the gasifier 20, the combustor seal pot 70, the combustor 30, and the gasifier seal pot 80 (introduced via fluidization gas lines 114a, 141B, 141C and/or 201, and 141D and/or 9B, respectively) comprises LP fuel gas, combustion air, or both. The fluidization gas in combustor 30 comprises primarily air. The gas feed rate to the combustor may be greater than, less than, or about 10, 15, 20, 25, 30, or 35 feet/s in certain embodiments.

The slope from combustor seal pot 70 into combustor 30 provides angle δ, such that the heat transfer media (e.g., sand), air, and flue gas will flow over and back into the combustor. The inlet flow of fluidization gas into the combustor may be determined by the amount and/or composition (e.g., the density) of heat transfer material therein. The inlet fluidization velocity is at least that amount sufficient to fluidize the heat transfer media within combustor 30. In embodiments, the inlet velocity to the combustor is greater than or about 10, 15, 20, 25, or 30 ft/s. In embodiments, the inlet velocity of fluidization gas into the bottom of the combustor is in the range of from about 15 to about 35 ft/s, from about 20 to about 35 ft/s, or from about 20 to about 30 ft/s. At higher elevations in the combustor, flue gas is created. This limits the suitable rate for introduction of fluidization gas into the combustor.

In embodiments, the combustor is operated in entrained flow mode. In embodiments, the combustor is operated in transport bed mode. In embodiments, the combustor is operated in choke flow mode. The bottom of the combustor (for example, at or near the inlet of circulating heat transfer media from the gasifier) may be operated at approximately or greater than about 1100° F., 1200° F., 1300° F., 1400° F., 1500° F., or 1600° F. and the exit of the combustor (at or near the top thereof; for example, at or near the exit of materials to cyclone(s)) may be operated at approximately or greater than about 1400° F., 1500° F., 1600° F., 1700° F., 1800° F., 1900° F., or 2000° F. Thus, the actual cubic feet of gas present increases with elevation in the combustor (due to combustion of the char and/or supplemental fuel). In embodiments, excess air flow is returned to the combustor.

The fluidization gas for the combustor may be or may comprise oxygen in air, oxygen-enriched air, substantially pure oxygen, for example, from a vacuum swing adsorption unit (VSA) or a pressure swing adsorption unit (PSA), oxygen from a cryogenic distillation unit, oxygen from a pipeline, or a combination thereof. The use of oxygen or oxygen-enriched air may allow for a reduction in vessel size, however, the ash fusion temperature must be considered. The higher the O₂ concentration in the combustor feed, the higher the temperature of combustion. The oxygen concentration is kept at a value which maintains a combustion temperature less than the ash fusion temperature of the feed. Thus, the maximum oxygen concentration fed into the combustor can be selected by determining the ash fusion temperature of the specific carbonaceous feed utilized in pyrolyzer 20. In embodiments, the fluidization gas fed to the bottom of the combustor comprises from about 20 to about 100 mole percent oxygen. In embodiments, the fluidization gas comprises about 20 mole percent oxygen (e.g., air). In embodiments, the fluidization gas comprises substantially pure oxygen (limited by the ash fusion properties of the char, supplemental fuel and heat transfer material fed thereto). In embodiments, the combustor fluidization gas comprises PSA tailgas.

The combustor may be designed for operation with about 10 volume percent excess oxygen in the combustion offgas. In embodiments, the combustor is operable with excess oxygen in the range of from about 0 to about 20 volume percent, from about 1 to about 14 volume percent, or from about 2 to about 10 volume percent excess O₂. In embodiments, the amount of excess O₂ fed to the combustor is greater than 1 volume percent and/or less than 14 volume percent. Desirably, enough excess air is provided that partial oxidation mode is avoided. In embodiments, DFB indirect gasifier 10 is operable with excess O₂ to the combustor in the range of greater than 1 to less than 10, and the flue gas comprises less than 15, 10, or 7 ppm CO. In embodiments, oxygen is utilized to produce more steam. In embodiments, for example, when the hot flue gas will be introduced into a second combustor (for example, without limitation, into the combustor of a second dual fluidized bed (DFB) indirect gasifier as disclosed, for example, in U.S. patent application Ser. No. 12/691,297 (now U.S. Pat. No. 8,241,523) filed Jan. 21, 2010, the disclosure of which is hereby incorporated herein for all purposes not contrary to this disclosure), the amount of excess oxygen may be in the range of from about 5 to about 25 percent, or may be greater than about 5, 10, 15, 20, or 25%, providing oxygen for a downstream combustor. In embodiments in which steam may be sold at value, more excess O₂ may be utilized to produce more steam for sale/use. In embodiments, a CO-rich, nitrogen-rich flue gas is produced by operation of combustor 30 of herein disclosed DFB gasifier 10 at excess oxygen of greater than 7, 10 or 15%.

In embodiments, supplemental fuels may be introduced into combustor 30. The supplemental fuels may be carbonaceous or non-carbonaceous waste streams and may be gaseous, liquid, and/or solid. For example, in embodiments, spent Fischer-Tropsch wax (which may contain up to about 5, 10, 15, 20, 25, or 30 weight percent catalyst) may be introduced into the combustor (and/or the gasifier, as discussed further hereinbelow). In embodiments, downstream processing apparatus 100 comprises Fischer-Tropsch synthesis apparatus, and spent catalyst and Fischer-Tropsch wax produced downstream in Fischer-Tropsch synthesis apparatus are recycled as fuel to the combustor. As discussed previously, such spent wax can alternatively or additionally also be introduced into the gasifier, providing that it will crack under the operating conditions therein. In embodiments, petcoke is fed to the combustor, as a fuel source.

In embodiments, a hydrocarbon laden stream (e.g., tar that may result from a tar removal system) is introduced into the combustor for recovery of the heating value thereof. The tar may be obtained from any tar removal apparatus known in the art, for example from a liquid absorber such as but not limited to an OLGA (e.g., a Dahlman OLGA) unit. Such removed tars comprise heavy hydrocarbons which may be reused as a component of feed/fuel to combustor 30. In embodiments, tailgas (e.g., Fischer-Tropsch tailgas, PSA tailgas, VSA tailgas and/or upgrader tailgas) is utilized as a fuel to the combustor.

In embodiments, a liquid feed such as, but not limited to, refinery tank bottoms, heavy fuel oil, liquid fuel oil (LFO), Fischer-Tropsch tar and/or another material (e.g., waste material) having a heating value, is introduced into the combustor. Nozzles on combustor seal pot 70 may be positioned above the dipleg for introduction of such liquid material(s) into the combustor. Nozzles may alternatively or additionally be positioned along the top portion of transfer line 25. This may help the liquid flow into the downleg and avoid production of cold spots on the refractory. In this manner, circulating heat transfer material may be utilized to circulate the liquid and the liquid may be carried into the combustor via the combustor fluidization gas (e.g., air).

In embodiments, the combustor is pressurized. The combustor may be operable at a pressure of greater than 0 psig to a pressure that is at least 2 psig less than the operating pressure of the gasifier. That is, in order to maintain continuous flow of materials from the combustor back into the gasifier, the pressure of the combustor, P_{C}, at the inlet to the combustor which may be measured by a pressure gauge located proximate the flue gas exit, is less than the gasifier/pyrolyzer pressure, P_{G}. The pressure at the HTM outlet of the combustor, P_{C,BOTTOM} (which must be greater than P_{G}), equals the sum of the pressure, P_{C}, at the top of the combustor and the head of pressure provided by the material in the combustor. The head of pressure provided by the heat transfer material/gas mixture within the combustor is equal to ρ_{C}gh, where ρ_{C} is the average density of the material (e.g., the fluidized bed of heat transfer material) within the combustor, g is the gravitational acceleration, and h is the height of the ‘bed’ of material within the combustor. The height of material (e.g., heat transfer material such as sand, and other components such as char and etc.) within the combustor is adjusted to ensure flow of materials back to the gasifier.

Thus, P_{C, BOTTOM} which equals P_{C}+ρ_{C}gΔh must be greater than the pressure of the gasifier, P_{G}. The heights and relationships between the combustor and gasifier are selected such that adequate pressure is provided to maintain continuous flow from the combustor to the gasifier and back.

In embodiments, the operating pressure of the combustor, P_{C}, is up to or about 40, 45, or 50 psig. In embodiments, based on 20-40 ft/s design criteria for gas velocity into the combustor, the maximum operating pressure of the combustor is about 45 psig. In embodiments, if the operating pressure of the combustor is increased, then the pressure energy can be recovered by the use of an expander. Thus, in embodiments, one or more expander is positioned downstream of the combustor gas outlet and upstream of heat recovery apparatus (discussed further hereinbelow). For example, when operated with pure oxygen, the diameter of the combustor may be smaller at the bottom than the top thereof. In embodiments, an expander is incorporated after the cyclones (because cyclone efficiency increases with higher pressures). In embodiments, one or more expander is positioned upstream of one or more baghouse filters, which may be desirably operated at lower pressures. In embodiments, the system comprises an expander downstream of one or more combustor cyclones. The expander may be operable at a pressure greater than 15, 20 or 30 psig. The one or more expanders may be operable to recover PV energy.

The superficial velocity selected for the gas/solid separators (which may be cyclones) will be selected to maximize efficiency and/or reduce erosion thereof. The cyclones may be operable at a superficial velocity in the range of from about 65 to about 100 feet/s, from about 70 to about 85 feet/s, or at about 65, 70, 75, 80, 85, 90, 95, 100 ft/s.

As shown in FIG. 1, the combustor outlet may be fluidly connected via combustor outlet line 106 with one or more combustor separators 60 (e.g., one or more HTM cyclones). The one or more cyclones may be configured in any arrangement, with any number of cyclones in series and/or in parallel. For example, a first bank of cyclones (e.g., from 1 to four or more cyclones) operated in parallel may be in series with a second bank of cyclones comprising from 1 to 4 or more cyclones in parallel and so on. DFB system 10 can comprise any number of banks of cyclones.

The one or more combustion HTM cyclones may be connected with one or more ash cyclones, and the ash cyclones may be followed by heat recovery. In such embodiments, the cyclones are high temperature, refractory-lined or exotic material cyclones. In embodiments, DFB indirect gasifier 10 comprises two, three or four combustor separators 60 in series. In embodiments, one to two banks of combustion HTM cyclones are followed by one or more banks of ash cyclones. In embodiments, two combustion HTM cyclones are followed by one or more than one combustor ash cyclone. The one or more HTM cyclone may have a performance specification of greater than 99, greater than 99.9 or greater than 99.98% removal of heat transfer material. Two or more combustor cyclones may be utilized to achieve the desired efficiency. In embodiments, the one or more ash cyclone may be operated to remove ash, for example, in order to reduce the size of a downstream baghouse(s). In embodiments, the one or more ash cyclones are operable to provide greater than about 60%, 70%, 80%, 85% or 90% ash removal from a gas introduced thereto.

In alternative embodiments, heat recovery apparatus is positioned between the HTM cyclone(s) and the ash removal cyclone(s). In such embodiments, combustor flue gas is introduced into one or more combustor HTM cyclones. The gas exiting the one or more HTM cyclones is introduced into one or more heat recovery apparatus. The gas exiting the one or more heat recovery apparatus is then introduced into one or more ash cyclones for removal of ash therefrom. The heat recovery apparatus may comprise one or more selected from the group consisting of air preheaters (e.g., a combustion air preheater), steam superheaters, waste heat recovery units (e.g., boilers), and economizers. In embodiments, heat recovery generates steam. In such embodiments comprising heat recovery upstream of ash removal, the one or more ash removal cyclones may not be refractory-lined, i.e. the one or more ash removal cyclones may be hard faced, but lower temperature cyclone(s) relative to systems comprising ash removal upstream of heat recovery. In embodiments, the ash removal cyclones are operable at temperatures of less than 400° F., less than 350° F., or less than 300° F. In embodiments, the lower temperature ash removal cyclones are fabricated of silicon carbide.

In embodiments, heat recovery is utilized to produce superheated steam. In embodiments, the superheated steam is produced at a temperature in the range of from about 250° F. to about 520° F., from about 250° F. to about 450° F., or from about 250° F. to about 400° F., and/or a pressure in the range of from about 100 psig to about 800 psig, 100 psig to about 700 psig, 100 psig to about 600 psig, 100 psig to about 500 psig, or from about 100 psig to about 400 psig.

In embodiments comprising heat recovery upstream of ash recovery, the face of the tubes may be built up and/or the velocity reduced in downward flow in order to minimize erosion of heat recovery apparatus (e.g., heat transfer tubes). The velocity to the cyclones in such embodiments may be less than 100, 95, 90, 85, 80, 75, 70, or 65 ft/s. If the velocity is reduced appropriately, the ash will not stick to the heat recovery apparatus (e.g., to waste heat boiler tubes and/or the superheater tubes), and will not unacceptably erode same.

As mentioned hereinabove, the seal pot fluidization gas can be or comprise another gas in addition to or in place of steam. For example, combustor flue gas and/or recycled synthesis gas may be utilized as fluidization gas for the GSP. In embodiments, the fluidization gas for the CSP, the GSP or both comprises steam. When recycled synthesis gas is utilized for fluidization of the GSP, the synthesis gas is returned to the gasifier and may provide additional clean synthesis gas from DFB gasifier 10. As mentioned hereinabove, by using non-steam as the fluidization gas in the seal pot(s), steam may be reduced or substantially eliminated from the product gas, thus increasing the Wobbe Number thereof, which may be beneficial for downstream processes at 100 (such as, for example, downstream power production). In embodiments, upgrader tailgas comprising sulfur is utilized as fluidization gas for the GSP.

Sulfur may exit DFB indirect gasifier 10 with the process gas, the combustor flue gas, and/or with the ash. Removal of the sulfur as a solid within gasification apparatus 10 may be desired. In embodiments, ash (e.g., wood ash) from the ash removal cyclones is utilized to remove mercaptan sulfur and/or H₂S from synthesis gas. In embodiments, mercaptan sulfur and/or H₂S removal is performed at a pH of greater than or about 7.5, 7.7, or 8. In embodiments, the ash (e.g., wood ash) comprises, for example, NaOH and/or Ca(OH)₂. In embodiments, a ‘sulfur-grabber’ or sulfur extraction material is added with the heat transfer material, such that sulfur may be removed with ash. The sulfur-grabber may comprise a calcium material, such as calcium oxide (CaO), which may be converted to calcium sulfide and exit the DFB 10 as a solid. In embodiments, ash water (comprising NaOH and/or Ca(OH)₂) is utilized to scrub sulfur from the outlet gases. For example, the system may comprise a scrubbing tower for cleaning the process gas. Depending on the basicity of the ash water, it may be utilized, in embodiments, as scrubbing water. Such scrubbing may be performed upstream of an ESP or other particulate separator configured to remove particulates.

Except for air, the different fluidization gases mentioned for CSP 70 may be utilized for the GSP as well. (In embodiments, a percentage of air (e.g., less than 4 volume percent) may be utilized on the GSP to provide higher temperature in the gasifier). The fluidization gas on the GSP may be selected from the group consisting of flue gas, steam, recycled synthesis gas, and combinations thereof.

For GSP 80, the minimum fluidization velocity for the heat transfer material is set at any point in time. That is, the minimum initial fluidization velocity is determined by the initial average particle size (e.g., 100 μm). After a time on stream (for example, 120 days), the heat transfer material may have a reduced average particle size (e.g., about 25 μm); thus the minimum fluidization velocity changes (decreasing with time on stream/HTM size reduction). The CSP and GSP may be selected such that they have a size suitable to handle the highest anticipated fluidization velocity, i.e. generally the start-up value. In embodiments, the minimum fluidization velocity of the GSP is initially high and decreases with time. However, it is possible that, if agglomerization occurs, the minimum fluidization velocity may increase. The minimum fluidization velocity is determined by the heat transfer material, in particular by the average particle size, the density, and/or the void fraction thereof. In embodiments, the minimum fluidization velocity is greater than about 0.2 ft/s. In embodiments, the minimum fluidization velocity is greater than about 1.5 ft/s. As the PSD decreases, seal pot fluidization velocity decreases.

As discussed in detail hereinabove, the diameter of the seal pot(s) depends on the number of dipleg penetrations, i.e. the number of upstream cyclones, and/or by the angles at which the diplegs enter into the seal pot. In embodiments, diplegs may be angled to allow shorter dipleg length. In embodiments, combustor cyclone diplegs enter the top of the gasifier seal pots, as with the CSP (where gasifier cyclone diplegs may enter a CSP 70). The CSP and/or the GSP may contain a distributor (96 and/or 97) configured for distributing gas uniformly across the cross-section (e.g., the diameter) thereof. In embodiments, the distributor is positioned at or near the bottom of the CSP and/or the GSP. In embodiments, to minimize/avoid erosion of the seal leg, the minimum distance between the distributor (i.e. the fluidization nozzles) at the bottom of the seal pot (GSP and/or CSP) and the bottom of the dipleg(s) projecting thereinto is 10, 11, 12, 13, 14, 15, 16, 17 or 18 inches. In embodiments, there is a distance of more than 15, 16, 17 or 18 inches between the seal pot distributor and the cyclone dipleg(s). Desirably, the dipleg-to-dipleg spacing and/or the dipleg-to-refractory ID spacing is at least 10, 11 or 12 inches. In embodiments, the dipleg-to-dipleg spacing and the dipleg-to-refractory ID spacing is at least about 12 inches. In embodiments, the diplegs are supported. Such support may be provided to minimize/prevent vibration of the diplegs. For the GSP, the seal may actually be within the dipleg of the combustor cyclone(s) and the GSP (since gasifier 20 is generally at a higher pressure than combustor separator 60).

GSP 80 and CSP 70 are designed with an adequate head of heat transfer material to minimize backflow. The height of the seal pot may be based on a design margin. In embodiments, the design margin is in the range of from about 1 psig to about 5 psig, or is greater than or about equal to 1, 2, 3, 4, or 5 psig. The head of heat transfer material (e.g., sand) will provide the ΔP (pressure drop) at least sufficient to prevent backflow of gas (i.e. to prevent gasifier backflow into one or more combustor separator and/or to prevent combustor backflow into one or more gasifier separator). The distribution of nozzles in both the CSP and the GSP may be in the range of from about one to about four nozzles per square foot. In embodiments, the distributors (95, 98, 96, 97) in any or all vessels (gasifier, combustor, CSP and GSP) comprise from about one to about four nozzles per ft².

In embodiments, one of the seal pots (either the combustor seal pot, CSP 70, or the gasifier seal pot, GSP 80) is replaced with an L valve or a J valve, with the remaining seal pot being a seal pot being designed as disclosed hereinabove. In embodiments, a suitable DFB indirect gasifier comprises one or more J valves as sealing device in place of a CSP 70. In embodiments, the DFB indirect gasifier 10 comprises one or more J valves as sealing device in place of a GSP 80. In embodiments, the DFB gasifier comprises multiple CSPs, one or more of which may be designed as disclosed herein. In embodiments, the multiple CSPs are substantially identical. In embodiments, the DFB indirect gasifier comprises multiple GSPs, one or more of which may be designed as disclosed herein. In embodiments, the multiple GSPs are substantially identical. In embodiments, DFB indirect gasifier 10 comprises at least one or one CSP 70 and at least one or one GSP 70. The seal of the CSP may be within the CSP. The seal on the GSP may simply be within a dipleg. In embodiments, a J valve is utilized on the gasifier rather than a GSP.

As mentioned hereinabove, the height of the CSP depends on the pressure needed for the seal, which is the differential pressure between the gasifier cyclone(s) 40 and/or 50 and the combustor 30. The combustor pressure plus a design margin may be utilized to determine the desired height of the CSP (i.e. the desired height of the heat transfer material therein). In embodiments, the pressure is near atmospheric. In embodiments, the ΔP is greater than 2 psig. In embodiments, the ΔP is in the range of from about 2 psig to about 25 psig, from about 2 psig to about 20 psig, or from about 2 psig to about 15 psig. In embodiments, the pressure differential is about 10, 12, 15, or 20 psig. Desirably, the ΔP is not less than about 2 psig, as pressure equalization is undesirable. In embodiments, a smaller ΔP is utilized, thus allowing the use of a shorter CSP 70.

Utilization of Gasification Product Gas.

A gasification product gas produced via a DFB system comprising at least one seal pot according to this disclosure may be utilized to produce downstream products in downstream processing apparatus 100. Such downstream products include, without limitation, Fischer-Tropsch synthesis products, non-Fischer-Tropsch chemicals, power, and combinations thereof. In such applications, a system may further comprise downstream synthesis gas conditioning apparatus, Fischer-Tropsch synthesis apparatus, Fischer-Tropsch product upgrading apparatus, hydrogen recovery apparatus, power generation apparatus, or a combination thereof.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide exemplary, procedural or other details supplementary to those set forth herein.

What is claimed is:

1. A method comprising
providing a seal pot comprising a substantially non-circular cross section and at least one penetration through a surface other than the top of the seal pot, wherein said seal pot is configured to balance pressure between vessels operated at a pressure differential while providing a seal between said vessels, wherein said pressure differential is less than about 25 psig;
introducing a fluidization medium into the seal pot to fluidize contents in the seal pot; and
operating said seal pot at a pressure of less than about 25 psig.

2. The method of claim 1, wherein the seal pot utilizes less fluidization medium than a conventional seal pot having a circular cross section, while providing equivalent seal.

3. The method of claim 1, wherein contents in the seal pot comprise heat transfer material and the seal pot utilizes less heat transfer material than a conventional seal pot having a circular cross section.

4. The method of claim 1, wherein the seal pot has reduced heat loss than a conventional seal pot having a circular cross section.

5. The method of claim 1, wherein the at least one penetration is configured for introduction of solids into the seal pot from a separator upstream of the seal pot.

6. The method of claim 5, wherein the separator comprises a dipleg extending through the at least one penetration through a surface other than the top of the seal pot.

7. The method of claim 6, wherein an angle between the dipleg passing through the at least one penetration through a surface other than the top of the seal pot and the surface other than the top of the seal pot is less than about 45°.

8. The method of claim 7, wherein the angle is less than about 30°.

9. The method of claim 5, wherein the separator is selected from the group consisting of gas/solid separators configured to separate solids from a gas in which solids are entrained.

10. The method of claim 9, wherein the upstream separator is a cyclone separator.

11. The method of claim 1, wherein the seal pot comprises two penetrations configured for introduction of solids into the seal pot from two separators upstream of the seal pot,
wherein each of the two upstream separators comprises a dipleg, wherein one dipleg extends through one penetration through a surface other than the top of the seal pot and the other dipleg extends through the other penetration through either the top of the seal pot or a non-top surface of the seal pot.

12. The method of claim 11, wherein the seal pot provides a desired separation distance between penetrations or between diplegs extending within the seal pot while having a reduced cross sectional area compared to a conventional seal pot having a circular cross section.

13. The method of claim 1, wherein the seal pot has a diameter of less than about 3 m.

14. The method of claim 1, wherein the seal pot has a diameter of less than about 1 m.

15. The method of claim 1, wherein the seal pot is connected with a gasifier having a throughput of less than 300 dry tons per day (DTPD).

16. The method of claim 1, wherein the seal pot comprises three penetrations configured for introduction of solids into the seal pot from three separators upstream of the seal pot, wherein each of the three upstream separators comprises a dipleg and the three diplegs extend through the three penetrations into the seal pot.

17. The method of claim 16, wherein the minimum distance between any two of the three diplegs extending into the seal pot is 10, 11, or 12 inches.

18. The method of claim 16, wherein the seal pot further comprises a distributor configured for distributing a fluidization gas, wherein the minimum distance between the distributor and each of the diplegs extending into the seal pot is 15, 16, 17 or 18 inches.

19. The method of claim 16, wherein two of the three penetrations pass through the top of the seal pot; or alternatively two or all of the three penetrations pass through a surface other than the top of the seal pot.

20. The method of claim 1, wherein the shape of the at least one penetration through a surface other than the top of the seal pot is substantially elliptical.
